(19) United States
(12) Patent Application Publication
(10) Pub. No.: US 2006/0190770 A1
(43) Pub. Date: Aug. 24, 2006

(54) Forward projection of correlated software failure information

(75) Inventor: Muir Lee Harding, Tualatin, OR (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Autodesk, Inc.

(21) Appl. No.: 11/062,687

(22) Filed: Feb. 22, 2005

(51) Int. Cl. G06F 11/00

(52) U.S. Cl. 714/38

(57) ABSTRACT

A method, apparatus and article of manufacture are provided for analyzing a program for failures. Error reporting data concerning the program's failures is collected from customer computers. Source code associated with the program is analyzed to generate analysis data. The analysis data is correlated with the error reporting data to determine patterns of errors that lead to failures in the program.

### BACKGROUND OF THE INVENTION

1. Field of the Invention

The present invention relates to computer software, and more particularly to forward projection of correlated software failure information.

2. Description of the Related Art

In today's world of computers and software, software programs are becoming increasingly complex in order to accomplish the plethora of tasks required by users. While complex programs historically comprised thousands of lines of source code, today's complex programs may contain millions of lines of code. With so many lines of code, these complex programs are prone to frequent failures (i.e., crashes), which often can cause lost productivity and a negative perception of the vendor by the customer. Thus, it has become imperative to locate the causes of these crashes, to the best of our ability, as the technology behind these software programs becomes ever more complex.

One method of locating the cause of software failures is analyzing or examining the source code of the programs to determine possible flaws. Two types of source code analysis are static source code analysis and dynamic source code analysis.

Static source code analysis tools, such as such as, LINT, KLOCWORK, and HEADWAY, examine source code and generate a report identifying potential problems with the source code, prior to compiling the source code. The identified potential problems can then be reviewed and/or rewritten in order to improve the quality and security of the source code before it is compiled. While static source code analysis highlights some problems with the source code prior to compiling the code, it requires a cumbersome process, with frequent manual intervention, to identify the majority of problems associated with the source code. In addition, static source code analysis cannot identify errors that may occur after the source code is compiled.

MICROSOFT makes a tool called FXCOP that works like static analysis, except that it works on the “compiled” intermediate language (IL) code. IL code is a low-level language that is designed to be read and understood by the common language runtime. FXCOP is a code analysis tool that checks NET managed code assemblies for conformance to the MICROSOFT .NET Framework Design Guidelines.

Dynamic source code analysis locates errors in the program while the program is executing, in the hope of reducing debugging time by automatically pinpointing and explaining errors as they occur. While dynamic source code analysis can reduce the need for a developer to recreate the precise conditions under which an error occurs, an error identified at execution may be far removed from the original developer and the documentation trail may not be adequate. Dynamic analysis has the additional drawback of only inspecting the parts of the software executed during the test. Generally, the area of coverage is much smaller than the body of software as a whole.

Both static analysis and dynamic analysis produce a large volume of information. A problem arises, however, in processing this large volume of information.

Another method of locating the cause of software failures is by extracting error reporting data (also known as customer error reports) from users. These reports often contain detailed information (stack traces, memory state, environment, etc.) about the software failures. Typically, the program includes an error reporting mechanism that allows a user to transmit the error reporting data to the vendor. The vendor can then identify the most common crashes, and prioritize its efforts in fixing the program.

The weakness of the customer error reporting is timing. Field failures are not desirable, and delays between the discovery of an error and its correction by the vendor can be costly for users.

The weakness of source code analysis is cost to the vendor. Static source code analysis generates information so voluminous that is often economically infeasible to resolve all issues, and no mechanisms exist to identify the “important” problems.

Accordingly, what is needed is a system for predicting software failures with a higher degree of accuracy than what presently exists. The present invention satisfies that need by correlating source code analysis with error reporting data to determine patterns of errors that lead to failures in programs.

### SUMMARY OF THE INVENTION

To address the requirements described above, the present invention discloses a method, apparatus and article of manufacture are provided for analyzing a program for failures. Error reporting data concerning the program's failures is collected from customer computers. Source code associated with the program is analyzed to generate analysis data. The analysis data is correlated with the error reporting data to determine patterns of errors that lead to failures in the program.

### BRIEF DESCRIPTION OF THE DRAWINGS

Referring now to the drawings in which like reference numbers represent corresponding parts throughout:

FIG. 1 schematically illustrates an exemplary hardware and software environment used in the preferred embodiment of the present invention; and

FIG. 2 illustrates the steps and functions performed by the server computer when correlating software failure information according to the preferred embodiment of the present invention.

### DETAILED DESCRIPTION OF THE PREFERRED EMBODIMENT

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

The present invention combines and improves on two existing but previously unrelated technologies supporting quality assurance for software systems: error reporting data (also known as field failure logging) and (static or dynamic) source code analysis. The result is a novel technique for improving software quality. Specifically, the present invention involves the correlation of source code analysis with error reporting data to determine patterns of errors that lead to failures in programs. This correlation may then be applied to source code in development and used to prioritize work on resolving identified issues.

Hardware and Software Environment

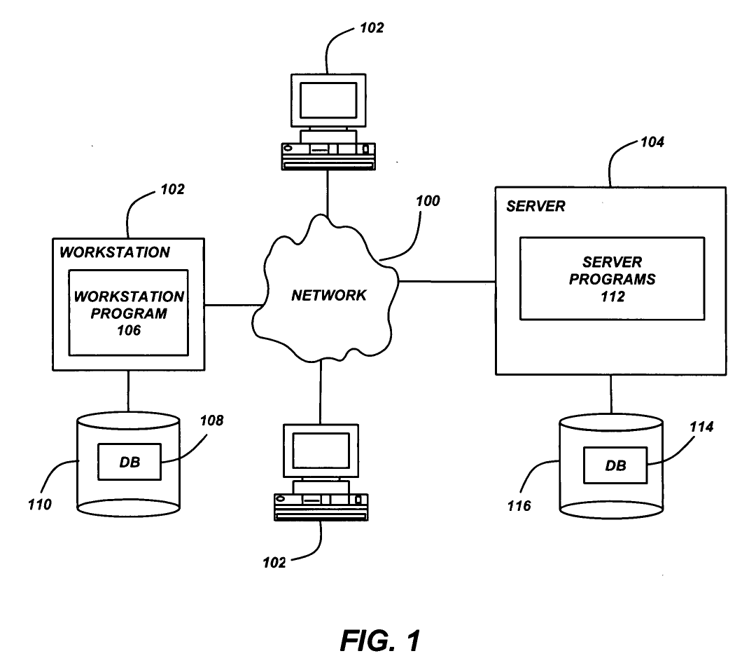

FIG. 1 schematically illustrates an exemplary hardware and software environment used in the preferred embodiment of the present invention. The present invention is usually implemented using a network 100 to connect one or more workstation computers 102 to one or more of the server computers 104. A typical combination of resources may include workstation computers 102 that comprise personal computers, network computers, etc., and server computers 104 that comprise personal computers, network computers, workstations, minicomputers, mainframes, etc. The network 100 coupling these computers 102 and 104 may comprise a LAN, WAN, Internet, etc.

Generally, the present invention is implemented using one or more programs, files and/or databases that are executed, generated and/or interpreted by the workstation computers 102 and/or the server computers 104. In the exemplary embodiment of FIG. 1, these computer programs and databases include a workstation program 106 executed by one or more of the workstations 102, and a database 108 stored on a data storage device 110 accessible from the workstation 102. In addition, these computer programs and databases include one or more server programs 112 executed by the server computer 104, and a database 114 stored on a data storage device 116 accessible from the server computer 104.

In this context, the workstation program 106, when it “crashes” or fails or reaches an error condition that causes it to terminate, generates error reporting data that is stored in the database 108. Generally, the workstation program 106 includes an error reporting mechanism that presents the users with an alert message that notifies them when a failure occurs and provides an opportunity to forward the error reporting data in the database 108 to the server computer 104 operated by the vendor for further analysis.

The error reporting data concerning the workstation program's 106 failure is collected by the server computer 104 from the workstation computers 102, and the server programs 112 executed by the server computer 104 store the error reporting data in the database 114 on the data storage device 116 accessible from the server computer 104. The error reporting data may comprise a “full dump” or “minidump” or “core dump” file, or any other information that may be considered useful by the vendor. The server programs 112 provide various tools for use in analyzing source code associated with the workstation program 106 to generate analysis data that is then correlated with the error reporting data received from the customers, in order to determine patterns of errors that lead to failures in the workstation programs 106, thereby leading to more robust and crash-resistant workstation programs 106.

Each of these programs and/or databases comprise instructions and data which, when read, interpreted, and executed by their respective computers, cause the computers to perform the steps necessary to execute the steps or elements of the present invention. The computer programs and databases are usually embodied in or readable from a computer-readable device, medium, or carrier, e.g., a local or remote data storage device or memory device coupled to the computer directly or coupled to the computer via a data communications device.

Thus, the present invention may be implemented as a method, apparatus, or article of manufacture using standard programming and/or engineering techniques to produce software, firmware, hardware, or any combination thereof. The term “article of manufacture” (or alternatively, “computer program carrier or product”) as used herein is intended to encompass one or more computer programs and/or databases accessible from any device, carrier, or media.

Of course, those skilled in the art will recognize that the exemplary environment illustrated in FIG. 1 is not intended to limit the present invention. Indeed, those skilled in the art will recognize that other alternative environments may be used without departing from the scope of the present invention.

Correlating Software Failure Information

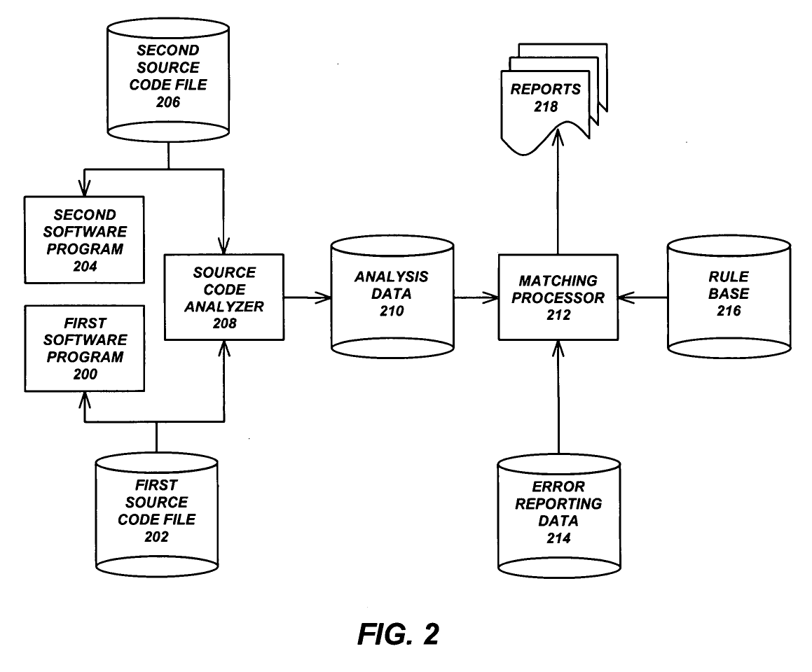

FIG. 2 illustrates the steps and functions performed by the server computer 104 when correlating software failure information according to the preferred embodiment of the present invention. Specifically, these steps or functions are performed by the server programs 112 when analyzing the source code associated with the workstation program 106 and the error reporting data received from the workstation computer 102. Moreover, these server programs 112 may be performed by a single server computer 104 or multiple server computers 104.

The server computer 104 stores a first software program 200 that is associated with a first source code file 202, wherein the first source code file 202 contains un-compiled source code. Similarly, the server computer 104 stores a second software program 204 that is associated with a second source code file 206, wherein the second source code file 206 contains un-compiled source code. Generally, the first and second software programs 200, 204 comprise different versions of the workstation program 106. For example, the second software program 204 may be a second or later version of the first software program 200.

A source code analyzer 208, which may be a static source code analysis tool or dynamic source code analysis tool, analyzes the first and/or second source code files 202, 206 in order to generate analysis data 210. The source code analyzer 208 performs an automated analysis of the first and/or second source code files 202, 206 to identify potential defects (e.g., memory violations, invalid pointer references, out-of-bounds array accesses, application programming interface (API) errors, etc.).

A matching processor 212 accesses the analysis data 210, as well as error reporting data 214. The matching processor 212 executes a matching algorithm that correlates or compares the analysis data 210 with the error reporting data 214, and identifies areas of overlap based on the comparison to determine patterns of errors that lead to failures in the first and/or second programs 200, 204, which are then output as a report 218 or other data. The areas of overlap may include any type of information that is the same or similar in both the analysis data 210 and the error reporting data 214. The comparison may be conducted on a line, module, object type, function name, or byte offset basis.

Note, however, that in one embodiment, the analysis data 210 is generated from the second source code file 206 for the second software program 204, while the error reporting data 214 relates to the first software program 200. Specifically, the error reporting data 214 may be from a current or previous release of the software, such as the first software program 200, and is compared to the analysis data 210 from a future or next release of software, such as the second software program 204. As a result, this comparison can be used to reduce and/or prevent failures in the future or next release of software, i.e., the second software program 204. In other words, error reporting data 214 from the first software program 200 may be combined with analysis data 210 from the second source code file 206 for the second software program 204 in order to make changes to the second software program 204 that minimize errors in the second software program 204 prior to compiling the second source code file 206 associated with the second software program 204.

The matching processor 212 typically operates according to a set of one or more rules stored in a rule base 216. These rules are used by the matching processor 212 to identify the areas of overlap. Moreover, the matching processor 212 may be utilized to establish the set of rules to predict future software failures.

Changes to the source code may be automated based on the data output by the matching processor 212 from the comparison of the analysis data 210 to the error reporting data 214. Alternatively, changes to the source code may be made manually based on the data output by the matching processor 212 from the comparison of the analysis data 210 to the error reporting data 214.

### CONCLUSION

This concludes the description of the preferred embodiment of the invention. The following describes some alternative embodiments for accomplishing the present invention.

For example, any type of computer, such as a mainframe, minicomputer, work station or personal computer, or network could be used with the present invention. In addition, any software program, application or operating system could benefit from the present invention. It should also be noted that the recitation of specific steps or logic being performed by specific programs are not intended to limit the invention, but merely to provide examples, and the steps or logic could be performed in other ways by other programs without departing from the scope of the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method of analyzing programs for failures, comprising:
(a) collecting error reporting data concerning the program's failures from customer computers; and
(b) analyzing source code associated with the program to generate analysis data; and
(c) correlating the analysis data with the error reporting data to determine patterns of errors that lead to failures in programs.

2. The method of claim 1, wherein the error reporting data comprises customer error reports.

3. The method of claim 1, wherein the analysis data is generated by a static or dynamic source code analysis tool.

4. The method of claim 1, wherein the error reporting data is from a current or previous release of the program and the analysis data is from a future or next release of the program.

5. The method of claim 1, wherein the analyzing step comprises analyzing source code associated with different versions of the program to generate analysis data.

6. The method of claim 1, wherein the correlating step comprises comparing the analysis data with the error reporting data, in order to identify areas of overlap based on the comparison.

7. The method of claim 6, wherein the comparing step is conducted on a line, module, object type, function name, or byte offset basis.

8. The method of claim 6, wherein the comparing step is performed by a matching processor.

9. The method of claim 8, wherein the matching processor operates according to a set of one or more rules stored in a rule base.

10. The method of claim 9, wherein the rules are used by the matching processor to identify the areas of overlap.

11. The method of claim 9, wherein the matching processor is used to establish the set of rules to predict future software failures.

12. The method of claim 1, wherein the patterns of errors are applied to source code in development and used to prioritize work on the source code.

13. The method of claim 12, wherein changes to the source code are automated based on data output from the comparison of the analysis data to the error reporting data.

14. The method of claim 12, wherein changes to the source code are made manually based on the data output from the comparison of the analysis data to the error reporting data.

15. An apparatus for analyzing programs for failures, comprising:
(a) means for collecting error reporting data concerning the program's failures from customer computers; and
(b) means for analyzing source code associated with the program to generate analysis data; and
(c) means for correlating the analysis data with the error reporting data to determine patterns of errors that lead to failures in programs.

16. The apparatus of claim 15, wherein the error reporting data comprises customer error reports.

17. The apparatus of claim 15, wherein the analysis data is generated by a static or dynamic source code analysis tool.

18. The apparatus of claim 15, wherein the error reporting data is from a current or previous release of the program and the analysis data is from a future or next release of the program.

19. The apparatus of claim 15, wherein the means for analyzing comprises means for analyzing source code associated with different versions of the program to generate analysis data.

20. The apparatus of claim 15, wherein the means for correlating comprises means for comparing the analysis data with the error reporting data, in order to identify areas of overlap based on the comparison.

21. The apparatus of claim 20, wherein the means for comparing is conducted on a line, module, object type, function name, or byte offset basis.

22. The apparatus of claim 20, wherein the means for comparing is performed by a matching processor.

23. The apparatus of claim 22, wherein the matching processor operates according to a set of one or more rules stored in a rule base.

24. The apparatus of claim 23, wherein the rules are used by the matching processor to identify the areas of overlap.

25. The apparatus of claim 23, wherein the matching processor is used to establish the set of rules to predict future software failures.

26. The apparatus of claim 15, wherein the patterns of errors are applied to source code in development and used to prioritize work on the source code.

27. The apparatus of claim 26, wherein changes to the source code are automated based on data output from the comparison of the analysis data to the error reporting data.

28. The apparatus of claim 26, wherein changes to the source code are made manually based on the data output from the comparison of the analysis data to the error reporting data.

29. An article of manufacture embodying logic for a method of analyzing programs for failures, comprising:
(a) collecting error reporting data concerning the program's failures from customer computers; and
(b) analyzing source code associated with the program to generate analysis data; and
(c) correlating the analysis data with the error reporting data to determine patterns of errors that lead to failures in programs.

30. The article of claim 29, wherein the error reporting data comprises customer error reports.

31. The article of claim 29, wherein the analysis data is generated by a static or dynamic source code analysis tool.

32. The article of claim 29, wherein the error reporting data is from a current or previous release of the program and the analysis data is from a future or next release of the program.

33. The article of claim 29, wherein the analyzing step comprises analyzing source code associated with different versions of the program to generate analysis data.

34. The article of claim 29, wherein the correlating step comprises comparing the analysis data with the error reporting data, in order to identify areas of overlap based on the comparison.

35. The article of claim 34, wherein the comparing step is conducted on a line, module, object type, function name, or byte offset basis.

36. The article of claim 34, wherein the comparing step is performed by a matching processor.

37. The article of claim 36, wherein the matching processor operates according to a set of one or more rules stored in a rule base.

38. The article of claim 37, wherein the rules are used by the matching processor to identify the areas of overlap.

39. The article of claim 37, wherein the matching processor is used to establish the set of rules to predict future software failures.

40. The article of claim 29, wherein the patterns of errors are applied to source code in development and used to prioritize work on the source code.

41. The article of claim 40, wherein changes to the source code are automated based on data output from the comparison of the analysis data to the error reporting data.

42. The article of claim 40, wherein changes to the source code are made manually based on the data output from the comparison of the analysis data to the error reporting data.
